(19) United States
(12) Patent Application Publication
(10) Pub. No.: US 2013/0134707 A1
(43) Pub. Date: May 30, 2013

(54) PIPE COUPLING FOR THE FLUID-TIGHT ATTACHMENT OF COMPONENTS IN AN AIR CONDITIONING SYSTEM

(71) Applicant: GM GLOBAL TECHNOLOGY OPERATIONS LLC, Detroit, MI (US)

(72) Inventors: Artem SERYI, Wiesbaden (DE); Bernd SCHUSTER, Gross Gerau (DE); Markus SCHAEDEL, Trebur (DE); Richard MUELLER, Bischofsheim (DE); Thomas LERCH, Ruesselsheim (DE)

(73) Assignee: GM GLOBAL TECHNOLOGY OPERATIONS LLC, Detroit, MI (US)

(21) Appl. No.: 13/685,514

(22) Filed: Nov. 26, 2012

(30) Foreign Application Priority Data
Nov. 26, 2011 (DE) 102011119513.4

(51) Int. Cl. F16L 21/035

(52) U.S. Cl. CPC F16L 21/035
USPC 285/374

(57) ABSTRACT

Disclosed is a pipe coupling for joining a pipe arranged in a pipe section with a line formed in a line section in a fluid-carrying manner, wherein a fluid-tight seal is established for the pipe coupling by way of a sealing washer, wherein the sealing washer is comprised of a sealing ring and a support ring, wherein the sealing ring is made out of an elastic material and situated in a sealing space, which extends in a radial direction from an outer surface of the pipe section up to the support ring, and in an axial direction from a first contact surface that runs orthogonal to the outer surface up to a second contact surface (6) on the line section running orthogonal to the line, wherein the sealing ring fills out 90% to 98% of the sealing space in a state where the support ring flatly abuts the contact surfaces.

### CROSS-REFERENCE TO RELATED APPLICATION

This application claims priority to German Patent Application No. 102011119513.4, filed Nov. 26, 2011, which is incorporated herein by reference in its entirety.

### TECHNICAL FIELD

This application relates to a pipe coupling for the fluid-tight attachment of a pipe arranged in a pipe section with a line configured in a line section, wherein a fluid-tight seal is established for the pipe coupling by way of a sealing washer.

### BACKGROUND

Generic sealing washers are designed similarly to a flat washer, and exhibit a support ring and a sealing ring that lies radially inward. The pipe section exhibits a collar. The middle of the sealing washers exhibits a hole, with which they can be slipped onto a pipe section until they come to about a first contact surface arranged on the collar. A second contact surface running essentially orthogonal to the line is situated on the line section. The contact surfaces on the collar or on the line section accommodate the sealing washer between them, so that the sealing ring is compressed, and the support ring flatly abuts the contact surfaces. The sealing ring is here compressed in such a way as to fit snugly on the contact surfaces.

Accordingly, it is desirable to provide a sealing washer that exhibits a sufficient tightness. Furthermore, other desirable features and characteristics of the present invention will become apparent from the subsequent detailed description and the appended claims, taken in conjunction with the accompanying drawings and the foregoing technical field and background.

### SUMMARY

In various embodiments, a pipe coupling for the fluid-tight attachment of a pipe arranged in a pipe section with a line configured in a line section is provided. A fluid-tight seal is established for the pipe coupling by way of a sealing washer. The sealing washer is comprised of a sealing ring and support ring. The sealing ring is made out of an elastic material and situated in a sealing space, which extends in a radial direction from an outer surface of the pipe section up to the support ring, and in an axial direction from a first contact surface that runs orthogonal to the outer surface up to a second contact surface on the line section running orthogonal to the line. The sealing ring fills out 90% to 98% of the sealing space in a state where the support ring flatly abuts the contact surfaces.

The pipe section is joined with the line section to route through the coolant. The pipe section can be a male part of a pipe coupling, and the line section can be a female part of the pipe coupling. The pipe section can be axially braced to the line section with suitable means. The line section can continue in a structural component or exhibit a tubular or cannular shape. “Orthogonal” essentially means rectangular, wherein slight deviations are possible within the framework of the usual production tolerances.

Because the sealing ring fills out only 90% to 98% of the sealing space even given a very strong contact pressure between the pipe section and the line section, the support ring alone bears the axial forces, not the elastic material of the sealing ring. As a result, no torque is lost on a screw connection joining the pipe section to the line section. The screwed connection can be established using a retainer nut or the like.

In an embodiment, a thickened region of a sealing ring in an unloaded state exhibits an expanded height measuring 110% to 145%, in particular 120% to 140%, in some embodiments 130% to 135% of the height of the support ring.

It has been shown that the selected height of the sealing ring was excessive for several known sealing washers. Choosing a smaller height with the aforementioned regions for the sealing ring also results in correspondingly less compression in an axial direction. As a consequence, the elastic material is still compressed enough to achieve a sealing effect, while at the same time keeping the deformation elastic, and not plastic.

In an embodiment, the thickened region is spaced apart a distance away from a radially outward joining surface between the sealing ring and support ring, wherein the ratio between the distance and the radial thickness of the sealing ring measures between 20% and 50%, in particular between 30% and 40%, in some embodiments between 32% and 38%.

This spacing for the thickened region prevents the elastic material from flowing over the support ring during axial compression. When spaced apart from the metal ring as specified above, the material has enough room to get out of the way.

In an embodiment, the height changes continuously in a radial direction from an origin to an inner radius lying radially inward, wherein an inclination derived from the change in height is always less than 2, in particular less than 1.9, in some embodiments less than 1.8.

Given a greater inclination, the elastic material can sometimes outwardly and inwardly swell in a radial direction, so that comparatively high shear forces can arise in the elastic material. The shear forces lead to elevated material fatigue. Correspondingly lowering the inclination increases a portion of the compressive stress while holding down the shear forces. In the final analysis, the slight inclination thus produces a load on the elastic material that is appropriate to the material involved.

In an embodiment, the height of the sealing ring is designed to be variable from an origin established on the sealing ring. Up until this origin, the sealing ring extends out of the support ring in a flush inlet. The origin is located a distance away from a radially outer joining surface between the sealing ring and support ring. Accordingly, the flush inlet is just as long as the distance. A ratio between the distance and the radial thickness of the sealing ring here measures between 5% and 20%, in particular between 8% and 17%, especially between 10% and 15%.

The length of the flush inlet or distance between the support ring and origin prevents the additional elastic material present in the elevation from being slipped over the support ring during compression.

In order to ensure optimal compatibility with a used coolant, the sealing ring can be fabricated both out of an ethylene propylene diene rubber and a hydrated acrylonitrile butadiene rubber.

The sealing ring exhibits a Shore hardness of 75 to 85, in particular of 78 to 82.

If the sealing space filled out by the sealing ring is diminished, the sealing ring is exposed to less axial compression. As a result, it may become necessary to select a comparatively high Shore hardness, so that the sealing ring abuts against sealing surfaces to be sealed with a sufficient axial contact pressure. The sealing surfaces are formed on the pipe section or line section, and face the sealing washer.

In an embodiment, the support ring is made out of metal. According to an alternative embodiment, the support ring is made out of plastic.

The metal can involve suitable metals and metal alloys that can be combined with the metals of the pipe section and line section. This yields a sealing washer that can absorb high axial forces, in which the elastic ring element is only exposed to the compression needed for achieving the sealing effect.

### BRIEF DESCRIPTION OF THE DRAWINGS

The present disclosure will hereinafter be described in conjunction with the following drawing figures, wherein like numerals denote like elements, and:

FIG. 1: is a schematic, cut view of a pipe coupling with a line section and a pipe section arranged thereon in accordance with an exemplary embodiment;

FIG. 2: is a schematic, magnified view of a region on FIG. 1 marked “A” in accordance with an exemplary embodiment;

FIG. 3: is a sealing washer with a support ring and an elastic sealing ring in an uncompressed state in accordance with an exemplary embodiment.

On the figures, identical or functionally similar structural components are marked with the same reference numbers.

### DETAILED DESCRIPTION

The following detailed description is merely exemplary in nature and is not intended to limit the disclosure or the application and uses. Furthermore, there is no intention to be bound by any theory presented in the preceding background or the following detailed description.

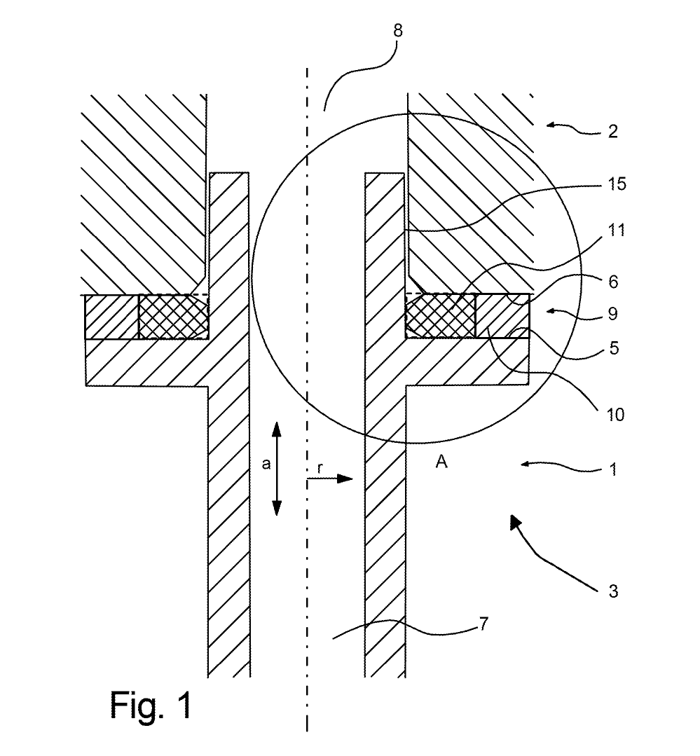

FIG. 1 shows a pipe coupling 3 comprised of a pipe section 1 and a line section 2. The interior of the pipe section 1 exhibits a pipe 7, which can be joined in a fluid-carrying and outwardly fluid-tight manner with a line 8 formed in the line section 2. The line section 2 can be part of a continuing pipe, or part of a housing. The housing can be part of an air dryer, a compressor, an evaporator or a capacitor. Situated on the pipe section 1 is a collar 4, which extends as a single piece out of the pipe section 1. The collar 4 exhibits a first contact surface 5 that faces the line section 2, and extends orthogonal to an axial direction a. The line section 2 exhibits a second contact surface 6 that faces the collar 4, and extends orthogonal to the axial direction a. The pipe section 1 projects into a line 8 arranged in the line section 2.

In order to assemble the pipe coupling, the sealing washer 9 is slipped over the pipe section 1 until it comes to abut the first contact surface 5. The pipe section 1 is now pushed into the line 3 until the sealing washer 9 touches the second contact surface 6 at the line section 2. The pipe section 1 is subsequently braced in the axial direction to the line section 2 using suitable means. Means not depicted for bracing the pipe section 1 to the line section 2 can here be provided for this purpose, e.g., screw connections or the like. The bracing operation compresses a sealing ring 11 formed on the sealing washer 9 in an axial direction a. The sealing ring 11 consists of an elastic material, and is enveloped by a support ring 10. The elastic material can be rubber, in particular ethylene propylene diene rubber (EPDM), hydrated acrylonitrile butadiene rubber (HNBR) or India rubber.

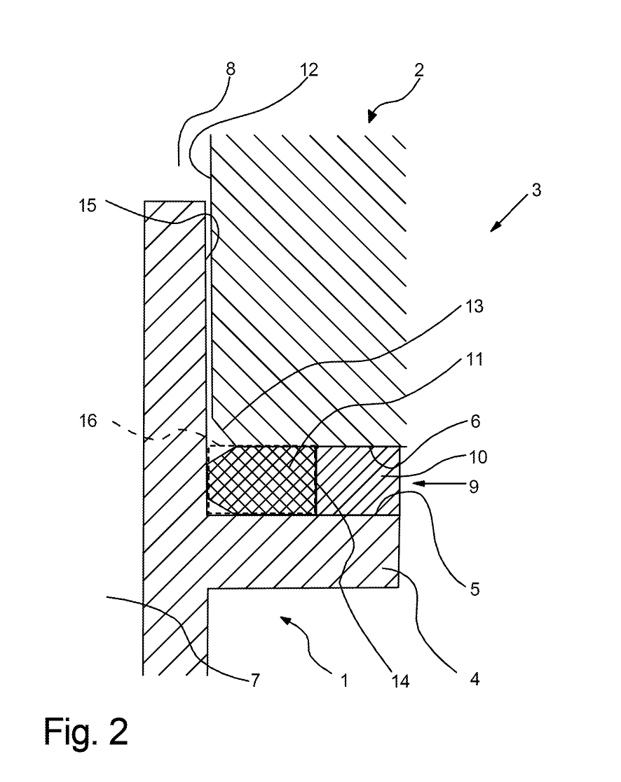

FIG. 2 presents a schematic view of a partial section of the connection between a pipe section 1 and line section 2, marked “A” on FIG. 1. The sealing washer 9 is depicted on a magnified scale therein. The sealing ring 11 can be rigidly joined with the support ring 10; for example, the sealing ring 11 can be vulcanized onto the support ring 10 at a joining surface 14.

In the assembled state, the support ring 10 flatly abuts the contact surfaces 5 and 6, so that an axial force can be transmitted. The support ring 10 here absorbs forces predominantly in an axial direction a. The sealing ring 11 is shown in a compressed state. In the compressed state, the sealing ring 11 tightly abuts the contact surfaces 5 and 6. The line section 2 further exhibits a 45° chamfer 13 to facilitate assembly of the pipe section 1 to the line section 2. The support ring 10 envelops the sealing ring 11, and holds the elastic material in a sealing space 16 shown with dashed lines, which extends in a radial direction r from an outer wall 15 of the pipe section 1 to the support ring 10 or the joining surface 14, and in an axial direction a from contact surfaces 5 and 6 situated on the pipe section 1 or line section 2. A space opened up by the chamfer 13 above the sealing space 16 is not included as part of the sealing space 16. The sealing element 11 fills out 90% to 98% of the sealing space 16 in the compressed state, but at the very least less than 100%. If in excess of 100% were to be filled out, the sealing ring 11 would flow into the gap between the support ring 10 and contact surfaces 5 and 6, or between the outer wall 15 of the pipe section 1 and an inner wall 12 of the line 8. Too high a pressure could cause the support ring 10 to burst open or the sealing ring 11 to tear. This is prevented by the diminished fill level of 90% to 98%.

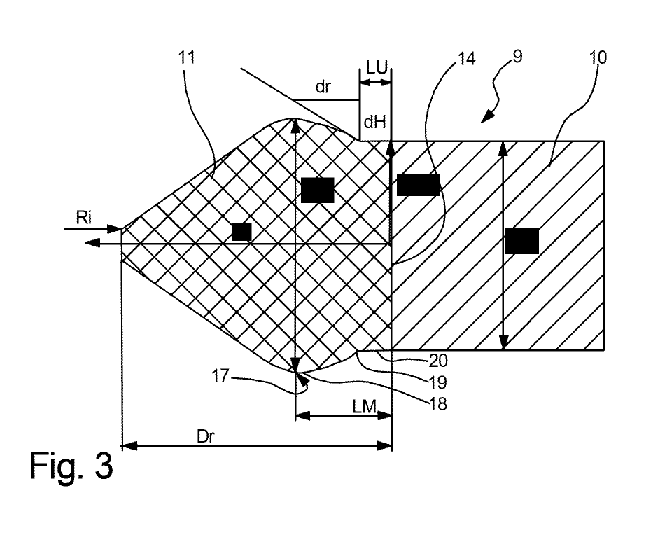

FIG. 3 presents a schematic cross section through the sealing washer 9. The sealing ring 11 is in an uncompressed state. The symmetrical sealing ring 11 has roughly a shovel-shaped cross section, with an elevation 18 situated in a thickened region 17. In the area of the elevation 18, a height h(R) of the sealing ring 11 is greater than in the surrounding region, in which the height h(R) varies over a coordinate R. The coordinate R runs parallel to the radial direction r at any location on the periphery of the sealing ring 9 in a negative radial direction r. The sealing ring 11 extends from an inner diameter Ri up to the support ring 10. In a region 19 that is adjacent to the support ring 10 and flush with the support ring 10, the contour essentially traces a straight line. The height h(R) increases continually from an origin 20 until reaching the expanded height hE. The height h(R) then diminishes continually. An incline dh/dR defined by the quotients of a change in height and change in coordinate R is always less than 2, in particular in proximity to the origin 20. This flattened configuration of the expanded height hE causes the sealing ring 11 to be exposed essentially only to pressure during axial bracing (see FIG. 2). Diminished shear forces here arise in the material of the sealing ring 11. This decreases a load acting on the material. The expanded height hE measures 110% to 145%, in particular 120% to 140%, and in some embodiments 130% to 135%, of the height hM of the metal ring. The spacing LU between the origin 20 and joining surface 14 ensures that the material of the sealing ring 11 will not flow over the support ring 10 during compression.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A pipe coupling for joining a pipe arranged in a pipe section with a line formed in a line section in a fluid-carrying manner, comprising:
a fluid-tight seal that is established for the pipe coupling by way of a sealing washer, wherein the sealing washer is comprised of a sealing ring and a support ring, wherein the sealing ring is made out of an elastic material and situated in a sealing space, which extends in a radial direction from an outer surface of the pipe section up to the support ring, and in an axial direction from a first contact surface that runs orthogonal to the outer surface up to a second contact surface on the line section running orthogonal to the line, wherein the sealing ring fills out 90% to 98% of the sealing space in a state where the support ring flatly abuts the contact surfaces.

2. The sealing washer according to claim 1, wherein a thickened region of the sealing ring in an unloaded state exhibits an expanded height measuring 110% to 145% of the height of the metal ring (hM).

3. The sealing washer according to claim 2, wherein a thickened region of the sealing ring in an unloaded state exhibits an expanded height measuring 120% to 140% of the height of the metal ring (hM).

4. The sealing washer according to claim 3, wherein a thickened region of the sealing ring in an unloaded state exhibits an expanded height measuring 130% to 135% of the height of the metal ring (hM).

5. The sealing washer according to claim 2, wherein the thickened region is spaced apart a distance away from a radially outward joining surface between the sealing ring and support ring, wherein the ratio between the distance and the radial thickness of the sealing ring measures between 20% and 50%.

6. The sealing washer according to claim 5, wherein the ratio between the distance and the radial thickness of the sealing ring measures between 30% and 40%.

7. The sealing washer according to claim 6, wherein the ratio between the distance and the radial thickness of the sealing ring measures between 32% and 38%.

8. The sealing washer according to claim 1, wherein the height changes continuously in a radial direction from an origin to an inner radius lying radially inward, wherein an inclination derived from the change in height is always less than 2.

9. The sealing washer according to claim 8, wherein the inclination derived from the change in height is always less than 1.9.

10. The sealing washer according to claim 9, wherein the inclination derived from the change in height is always less than 1.8.

11. The sealing washer according to claim 1, wherein a height is designed to be variable from an origin established on the sealing ring, wherein the origin is located a distance away from a radially outer joining surface between the sealing ring and support ring, wherein a ratio between the distance and the radial thickness of the sealing ring measures between 5% and 20% of the support ring.

12. The sealing washer according to claim 11, wherein the ratio between the distance and the radial thickness of the sealing ring measures between 8% and 17% of the support ring.

13. The sealing washer according to claim 12, wherein the ratio between the distance and the radial thickness of the sealing ring measures between 10% and 15% of the support ring.

14. The sealing washer according to claim 1, wherein the sealing ring is comprised of an ethylene propylene diene rubber.

15. The sealing washer according to claim 1, wherein the sealing ring is comprised of a hydrated acrylonitrile butadiene rubber.

16. The sealing washer according to claim 1, wherein the sealing ring exhibits a Shore hardness of 75 to 85.

17. The sealing washer according to claim 16, wherein the sealing ring exhibits a Shore hardness of 78 to 82.

18. The sealing washer according to claim 1, wherein the support ring is made out of metal.

19. The sealing washer according to claim 1, wherein the support ring is made out of plastic.
